(19) United States
(12) Patent Application Publication
(10) Pub. No.: US 2004/0255725 A1
(43) Pub. Date: Dec. 23, 2004

(54) Unidirectional bucking device of ratchet wrench

(76) Inventor: Tsung-Chieh Chang, Taichung (TW)

Correspondence Address: Tsung-Chieh Chang, 235 Chung-Ho, Box 8-24, Taipei, TW

(21) Appl. No.: 10/899,432

(22) Filed: Jul. 26, 2004

Related U.S. Application Data
(63) Continuation-in-part of application No. 10/284,526, filed on Nov. 1, 2002, now abandoned.

(51) Int. Cl. B25B 13/46

(52) U.S. Cl. 81/60

(57) ABSTRACT

A unidirectional bucking device of a ratchet wrench comprises a wrench body, a ratchet wheel, a brake block, an elastomer, and a plug cover. An outer periphery of the ratchet wheel is formed with a teeth surface and an inner side of the ratchet wheel is formed with a clamping seat. One end of the brake block is formed as a braking surface. A taper space with an apex having an angle is formed between the braking surface and the receiving groove so that when the brake block is engaged and braked by the ratchet wheel. The brake block moves through a small extent so as to adjust the engagement of the teeth surface and the ratchet teeth surface and the teeth surface, and the ratchet wheel are hidden within the receiving groove.

The present invention is a continuation in part of U.S. Pat. No. 10/284,526 assigned to and invented by the inventor of the present invention. Thus the contents of the U.S. patent Ser. No. 10/284,526 is incorporated into the present invention as a part of the specification of the present invention.

### FIELD OF THE INVENTION

The present invention relates to ratchet wrenches, and particularly to unidirectional bucking device of a ratchet wrench

### BACKGROUND OF THE INVENTION

Referring to FIGS. 1, a prior art unidirectional ratchet wrench has a receiving chamber which is formed horizontally. When the ratchet block is installed therewithin. The operation angle between the brake teeth and the ratchet wheel is larger so that the component of the force applied to the spanner is small. The engagement of the teeth of the brake teeth and the ratchet wheel is not tight. The ratchet wheel is possibly buckled motionlessly.

Referring to FIG. 2, a prior art ratchet wrench is shown. In this prior art, although the brake block is inclined. However, the arrangement of the orientation and position of a receiving groove for receiving the brake block causes that the precision is low and cost is high. When the brake block is engaged with the ratchet wheel, since an axial line of the receiving groove has an angle with respect to the axial line of the wrench body passing through the center of the ratchet wheel so that the effect of the wrench body is low.

With reference to FIG. 3, a prior art disclosed by the inventor of the present invention, in which a unidirectional a ratchet wrench is disclosed. In this prior art, the wrench is formed by a wrench, a ratchet wheel, a brake block, a spring, and a stud. The wrench body serves to receive the receiving chamber of the brake block and has an angle θ with respect to a horizontal axial line of the ratchet wheel with an angle of 12 to 18 degrees so that the wrench can be effectively operated. However, in this prior art, the ratchet wheel can not be tightly engaged to the brake block with a higher precision (except that a special machining process is used, but this will increase the cost). When the brake block is engaged with the ratchet wheel, the brake block will tightly resist against an inner wall of the receiving chamber. Thereby, a reacting force generates so that the brake block resists against the teeth of the ratchet wheel. Not only the wrench body can only suffer from a finite twisting force and thus the ratchet teeth are easily destroyed.

### SUMMARY OF THE INVENTION

Accordingly, the primary object of the present invention is to provide a unidirectional bucking device of a ratchet wrench, wherein a brake block moves through a small extent so as to adjust the engagement of a teeth surface and a ratchet teeth surface, and a teeth surface and a ratchet wheel are hidden within the receiving groove.

To achieve above mentioned object, the present invention provides a unidirectional bucking device of a ratchet wrench comprising a wrench body, a ratchet wheel, a brake block, an elastomer, and a plug cover. One end of the wrench body is formed with a head portion. A receiving chamber and a receiving groove are installed in the head portion for installing the ratchet wheel, brake block, and elastomer. The receiving groove penetrates through the head portion and is tilt to a longitudinal axial line through the wrench body. The brake block and elastomer are installed in the receiving groove. An outer periphery of the ratchet wheel is formed with a teeth surface and an inner side of the ratchet wheel is formed with a clamping seat. One end of the brake block is formed as a braking surface. A taper space with an apex having an angle is formed between the braking surface and the receiving groove so that when the brake block is engaged and braked by the ratchet wheel, the brake block moves through a small extent so as to adjust the engagement of the teeth surface and the ratchet teeth surface and the teeth surface, and the ratchet wheel are hidden within the receiving groove.

The various objects and advantages of the present invention will be more readily understood from the following detailed description when read in conjunction with the appended drawing.

### BRIEF DESCRIPTION OF THE DRAWINGS

FIG. 1 is an assembled cross sectional view of a first prior art.

FIG. 2 is a cross sectional view of a second prior art.

FIG. 3 is an assembled cross sectional view of a third prior art.

FIG. 4 is an exploded schematic view of the present invention.

FIG. 5 is an assembled cross sectional view showing that the present invention rotates idly.

FIG. 6 is an assembled cross sectional view showing the engagement and brake operations in the present invention.

FIG. 7 is an enlarged schematic view showing that the present invention can be adjusted finely.

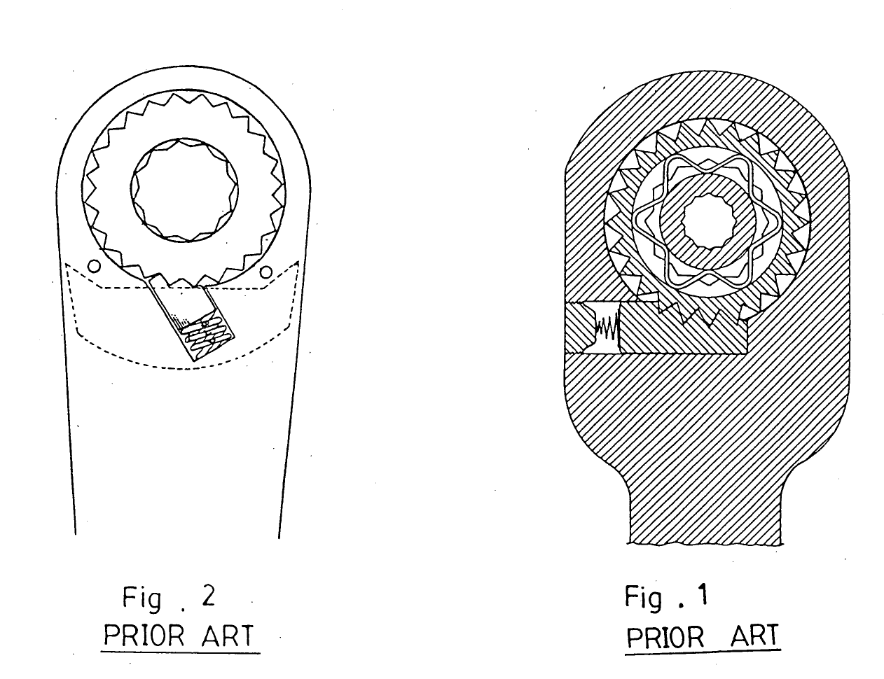

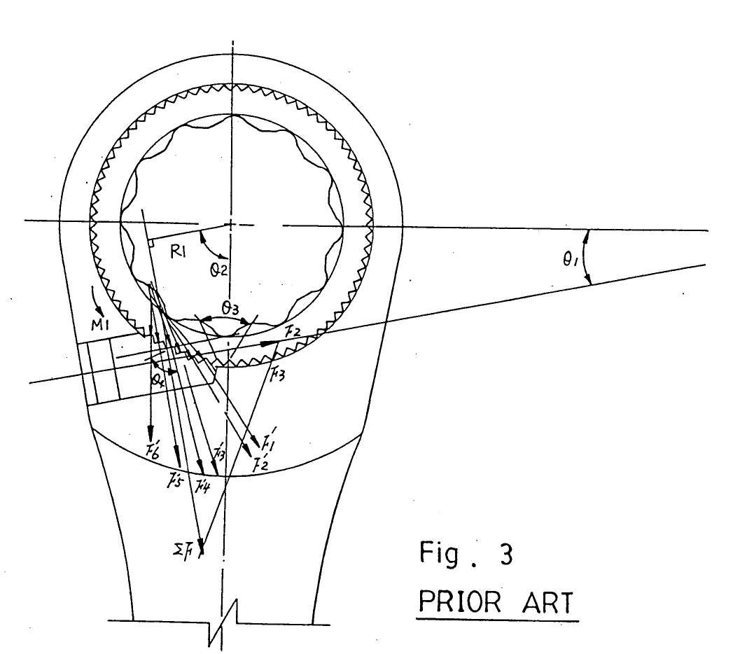

### DETAILED DESCRIPTION OF THE PREFERRED EMBODIMENTS

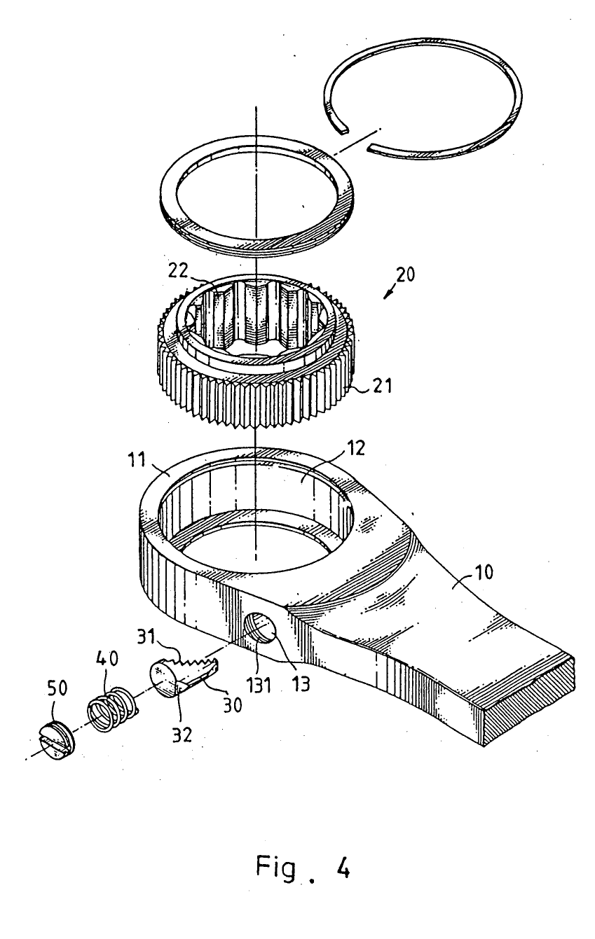

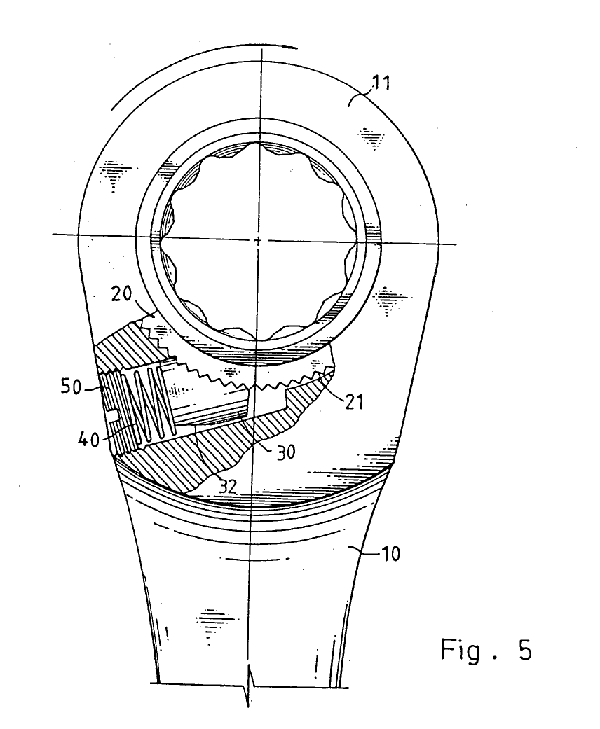

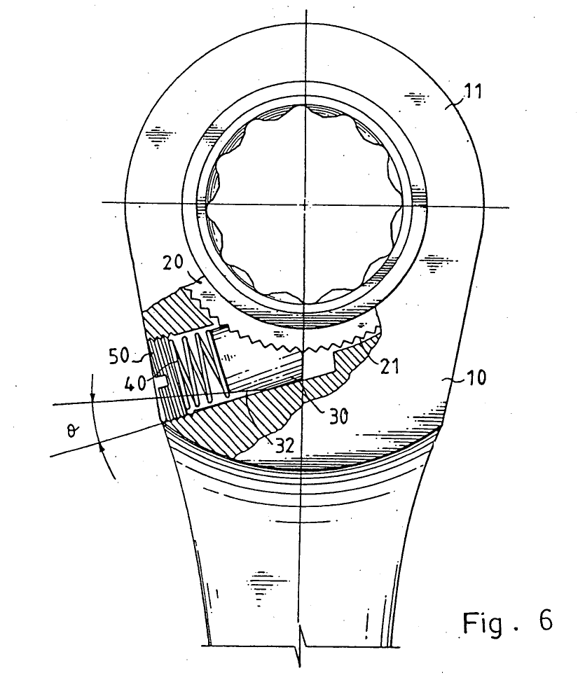

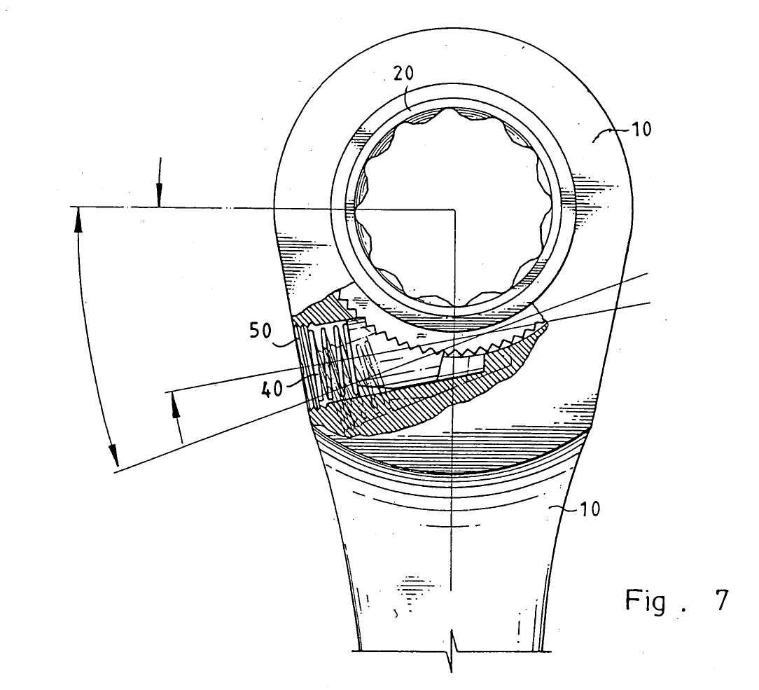

Referring to FIGS. 4 to 7, the unidirectional bucking device of a ratchet wrench of the present invention is illustrated. The unidirectional bucking device of a ratchet wrench includes a wrench body 10, a ratchet wheel 20, a brake block 30, an elastomer 40, and a plug cover 50, etc.

With reference to FIGS. 4 to 6, one end of the wrench body 10 is formed with a head portion 11. A receiving chamber 12 and a receiving groove 13 are installed in the head portion 11 for installing the ratchet wheel 20, brake block 30, and elastomer 40. The receiving groove 13 penetrates through the head portion 11 and is obliquely to a line vertical to a longitudinal axial line through the wrench body 10. Near the outer side of the receiving groove 13 is formed with thread section 131 for screwing the plug cover 50.

The ratchet wheel 20 has an annular shape. An out periphery of the ratchet wheel 20 is formed with a teeth surface 21 and an inner side of the ratchet wheel 20 is formed with a clamping seat 22 for engaging a nut or other screwing elements.

The brake block 30 has a wedge shape. One end thereof has a ratchet teeth surface 31 which is engageable to the teeth surface 21 of the ratchet wheel 20. A bottom of another end thereof is formed with a chamfered braking surface 32

The elastomer 40 is an elastic element and is installed between the brake block 30 and the plug cover 50. By the resilient force of the elastomer 40, the brake block 30 and ratchet wheel 20 are buckled and thus rotates idly.

The plug cover 50 is screwedly installed in the receiving groove 13 for fixing the elastomer 40 and brake block 30.

Thereby, one end of the brake block 30 is chamfered as a braking surface 32. When the brake block 30 is installed in the receiving groove 13, a taper space with an apex having an angle θ is formed between the braking surface 32 and the receiving groove 13 so that when the brake block 30 is engaged and braked by the ratchet wheel 20, the brake block 30 may move through a small extent (referring to FIG. 7) so as to adjust the engagement of the teeth surface 21 and the ratchet teeth surface 31 so that the two can be hidden within the receiving groove 13.

Furthermore, in the present invention, a diameter of the brake block is equal to that of the elastomer and also equal to that of the plug cover so that the brake block, elastomer and the plug cover are steadily installed with the receiving groove. The chamfered surface is straight and a lateral side of the brake block contacts a wall of the groove is straight so that the operation of the brake block is steady. The angle between the chamfered surface and a wall of the receiving groove is between 12 degrees to 18 degrees.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A unidirectional bucking device of a ratchet wrench comprising:
a wrench body, one end of the wrench body being formed with a head portion; a receiving chamber and a receiving groove being formed in the head portion, the receiving groove penetrating through the head portion and being tilt to a line vertical to a longitudinal axial line through the wrench body;
a ratchet wheel received in the receiving chamber, an outer periphery of the ratchet wheel being formed with a teeth portion and an inner side of the ratchet wheel being formed with a clamping seat;
a brake block installed in the receiving groove, the brake block comprising:
a teeth surface teeth and chamfered at one end of the brake block;
a braking surface chambered at an opposite end of the brake block,
wherein in installation, the teethed surface being positioned toward the receiving chamber; and the braking surface being located so that a space is formed between the braking surface and a wall of the receiving groove; wherein when the brake block is engaged and braked by the ratchet wheel, the brake block moves through a small extent so as to adjust the engagement of the teeth portion and the ratchet teeth portion; and the teeth portion and the ratchet wheel are hidden within the receiving groove;
an elastomer installed in the receiving groove and after the brake block, and
a plug cover installed in the receiving groove and after the elastomer and at an outer surface of the head portion.

2. The unidirectional bucking device of a ratchet wrench as claimed in claim 1, wherein a diameter of the brake block is equal to that of the elastomer and also equal to that of the plug cover so that the brake block, elastomer and the plug cover are steadily installed with the receiving groove.

3. The unidirectional bucking device of a ratchet wrench as claimed in claim 1, wherein the chamfered surface is straight and a lateral side of the brake block contacts a wall of the groove is straight so that the operation of the brake block is steady.

4. The unidirectional bucking device of a ratchet wrench as claimed in claim 1, wherein the angle between the chamfered surface and a wall of the receiving groove is between 12 degrees to 18 degrees.
